(19) United States
(12) Patent Application Publication
(10) Pub. No.: US 2025/0251655 A1
(43) Pub. Date: Aug. 7, 2025

(54) ILLUMINATION SYSTEM AND PROJECTION DEVICE

(71) Applicant: Coretronic Corporation, Hsin-Chu (TW)

(72) Inventors: Yao-Shun Lin, Hsin-Chu (TW); Chia-Hao Wang, Hsin-Chu (TW)

(73) Assignee: Coretronic Corporation, Hsin-Chu (TW)

(21) Appl. No.: 19/047,593

(22) Filed: Feb. 6, 2025

(30) Foreign Application Priority Data
Feb. 7, 2024 (CN) 202410174612.6

(51) Int. Cl. G03B 21/20; G02B 27/10

(52) U.S. Cl. CPC G03B 21/204; G02B 27/1006; G03B 21/2013; G03B 21/2066; G03B 21/2073; G03B 21/208

(57) ABSTRACT

An illumination system includes a laser light source, a wavelength conversion element, a first supplementary light source and a light splitting element. The laser light source is used to provide a laser beam. The wavelength conversion element is used to convert the laser beam into a converted light beam. The first supplementary light source is used to provide a first supplementary light beam. The light splitting element meets one of the following conditions: (1) allowing the laser beam to pass through, allowing the first supplementary light beam with the first polarization state to pass through, and reflecting the converted light beam with the second polarization state; or (2) reflecting the laser beam, reflecting the first supplementary light beam having the second polarization state, and allowing the converted light beam having the first polarization state to pass through.

### CROSS-REFERENCE TO RELATED APPLICATION

This application claims the priority benefit of China application serial no. 202410174612.6, filed on Feb. 7, 2024. The entirety of the above-mentioned patent application is hereby incorporated by reference herein and made a part of this specification.

### BACKGROUND

### Technical Field

The disclosure relates to an optical device, and in particular to an illumination system and a projection device.

### Description of Related Art

A projection device (a projector) is a display device used to produce a large-size picture. In current illumination systems of projection devices, blue lasers are often used to excite yellow-green fluorescent light (a converted light beam) as the source of the illumination light beam. For better optical effects, additional red lasers and/or green lasers are used as supplementary light sources. However, for a dichroic element (a dichroic mirror) to guide additional red laser and/or green laser, the dichroic element may lose energy in part of the yellow-green fluorescent band, which reduces the light efficiency, thereby leading to a poor quality of the projected picture.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The disclosure provides an illumination system and a projection device that can improve the usage efficiency of light to achieve proper optical effects.

Other objects and advantages of the disclosure can be further understood from the technical features disclosed in the disclosure.

In order to achieve one, part or all of the above objects or other objects, the disclosure provides an illumination system, including a laser light source, a wavelength conversion element, a first supplementary light source, and a light splitting element. The laser light source is used to provide a laser beam. A wavelength of the laser beam is within the first wavelength range. The wavelength conversion element is configured on a transmission path of the laser beam. The wavelength conversion element is used to convert the laser beam into a converted light beam. The first supplementary light source is used to provide a first supplementary light beam. A wavelength of the first supplementary light beam is within the second wavelength range. A polarization state of the first supplementary light beam includes a first polarization state and a second polarization state. The light splitting element is configured on a transmission path of the laser beam, the first supplementary light beam, and the converted light beam. The light splitting element meets one of the following conditions: (1) allowing the laser beam with a wavelength within the first wavelength range to pass through, allowing the first supplementary light beam with a wavelength within the second wavelength range and having the first polarization state to pass through, and reflecting the converted light beam with a wavelength within the second wavelength range and having the second polarization state; or (2) reflecting the laser beam with a wavelength within the first wavelength range, reflecting the first supplementary light beam with a wavelength within the second wavelength range and having a second polarization state, and allowing the converted light beam with a wavelength within the second wavelength range and having the first polarization state to pass through.

In order to achieve one, part or all of the above objects or other objects, the disclosure further provides a projection device, including the illumination system, at least one light valve, and a projection lens. The illumination system is used to provide an illumination light beam. The illumination system includes the laser light source, the wavelength conversion element, the first supplementary light source, and the light splitting element. The laser light source is used to provide the laser beam. The wavelength of the laser beam is within the first wavelength range. The wavelength conversion element is configured on the transmission path of the laser beam. The wavelength conversion element is used to convert the laser beam into the converted light beam. The first supplementary light source is used to provide the first supplementary light beam. The wavelength of the first supplementary light beam is within the second wavelength range. The polarization state of the first supplementary beam includes the first polarization state and the second polarization state. The light splitting element is configured on the transmission path of the laser beam, the first supplementary light beam, and the converted light beam. The light splitting element meets one of the following conditions: (1) allowing the laser beam with a wavelength within the first wavelength range to pass through, allowing the first supplementary light beam with a wavelength within the second wavelength range and having the first polarization state to pass through, and reflecting the converted light beam with a wavelength within the second wavelength range and having the second polarization state; or (2) reflecting the laser beam with a wavelength within the first wavelength range, reflecting the first supplementary light beam with a wavelength within the second wavelength range and having a second polarization state, and allowing the converted light beam with a wavelength within the second wavelength range and having the first polarization state to pass through. The at least one light valve is configured on the transmission path of the illumination light beam to convert the illumination light beam into an image beam. The projection lens is configured on the transmission path of the image beam and is used to project the image beam out of the projection device.

Based on the above, embodiments of the disclosure have at least one of the following advantages or effects. Under the architecture of the illumination system with the supplementary light sources and the projection device of the disclosure, through the design of the light splitting element, the usage efficiency of light can be improved to achieve proper optical effects.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a projection device according to an embodiment of the disclosure.

FIG. 2 is a schematic diagram of an illumination system according to an embodiment of the disclosure.

FIG. 3 is a reflectivity curve in different wavelength bands of the light splitting element of the illumination system of FIG. 2.

FIG. 4 is a schematic diagram of an illumination system according to another embodiment of the disclosure.

FIG. 5 is a schematic diagram of an illumination system according to another embodiment of the disclosure.

FIG. 6 is a reflectivity curve in different wavelength bands of the light splitting element of the illumination system of FIG. 5.

FIG. 7 is a schematic diagram of an illumination system according to another embodiment of the disclosure.

FIG. 8 is a schematic diagram of an illumination system according to another embodiment of the disclosure.

FIG. 9 is a reflectivity curve in different wavelength bands of the light splitting element of the illumination system of FIG. 8.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

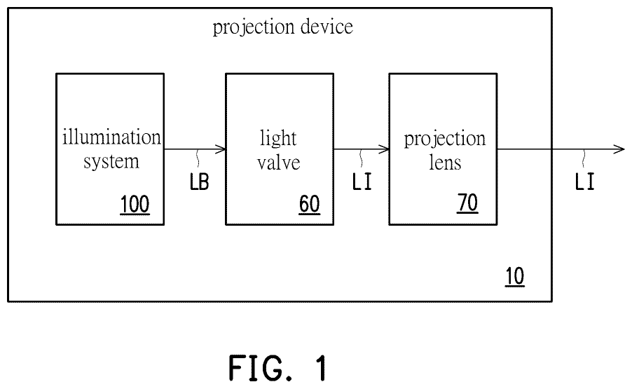

FIG. 1 is a schematic diagram of a projection device according to an embodiment of the disclosure Referring to FIG. 1, this embodiment provides a projection device 10 including an illumination system 100, at least one light valve 60, and a projection lens 70. The illumination system 100 is used to provide an illumination light beam LB. The at least one light valve 60 is disposed on a transmission path of the illumination light beam LB to convert the illumination light beam LB into an image beam L1. The projection lens 70 is disposed on a transmission path of the image beam L1, and is used to project the image beam L1 out of the projection device 10 to project an image to a projection target (not shown), such as a screen, a wall, or a desktop.

The light valve 60 is, for example, a reflective light modulator such as a liquid crystal on silicon panel (LCOS panel) or a digital micro-mirror device (DMD). In some embodiments, the light valve 60 may also be a transmissive optical modulator such as a transparent liquid crystal panel, an electro-optical modulator, a magneto-optic modulator, or an acousto-optic modulator (AOM). The disclosure does not limit the type and category of the light valve 60. Sufficient teaching, suggestion, and implementation description of detailed steps and implementation means of a method of converting the illumination light beam LB into the image beam L1 by the light valve 60 may be obtained from the common knowledge in the field, and therefore are not repeated here. In different embodiments, the number of the light valves 60 may be configured from one to three light valves 60 according to the optical design of the illumination system 100.

The projection lens 70 includes, for example, a combination of one or more optical lenses with refractive power, such as various combinations of non-planar lenses such as biconcave lenses, biconvex lenses, meniscus lenses, convex-concave lenses, plano-convex lenses, and plano-concave lenses. In an embodiment, the projection lens 70 may further include a plane optical lens to project the image beam L1 from the light valve 60 to the projection target in a reflective manner. The disclosure does not limit the type and category of the projection lens 70.

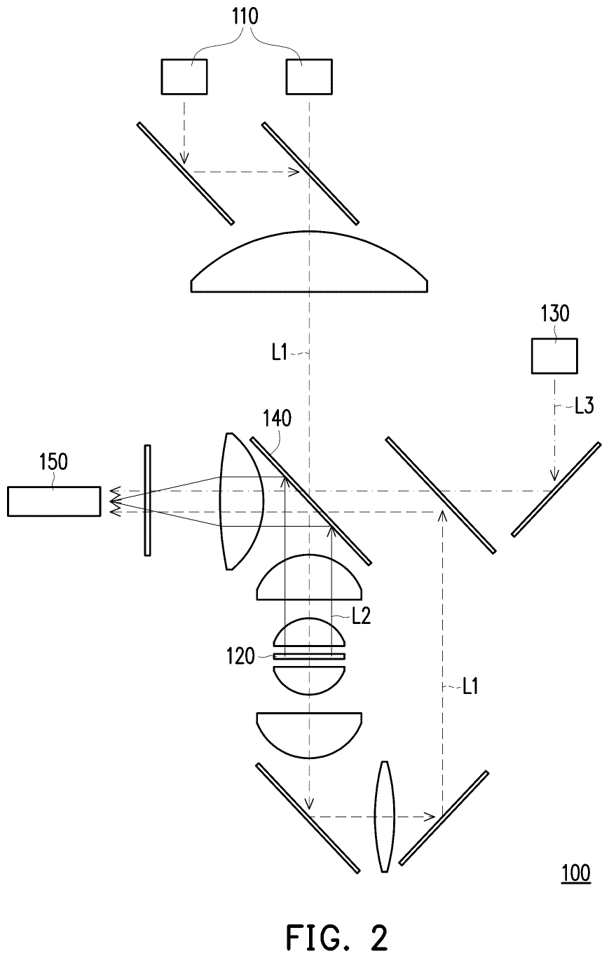

FIG. 2 is a schematic diagram of an illumination system according to an embodiment of the disclosure. Referring to FIG. 2, the illumination system 100 of this embodiment at least may be applied to the projection device 10 of FIG. 1. The illumination system 100 includes a laser light source 110, a wavelength conversion element 120, a first supplementary light source 130, and a light splitting element 140. The laser light source 110 is used to provide a laser beam L1. A wavelength of the laser beam L1 is within a first wavelength range. For example, in this embodiment, the laser light source 110 is, for example, at least one blue laser diode or blue laser diode array, used to provide the laser beam L1 of a blue color. The first wavelength range falls within 380 nm and 495 nm, and a main wavelength thereof is, for example, 455 nm.

The wavelength conversion element 120 is configured on a transmission path of the laser beam L1. The wavelength conversion element 120 is used to convert the laser beam L1 into a converted light beam L2. For example, in this embodiment, the wavelength conversion element 120 is a phosphor wheel. The wavelength conversion element 120 includes a wheel and a wavelength conversion material. The wavelength conversion element 120 has a wavelength conversion area and a non-wavelength conversion area. The wheel is used to carry the wavelength conversion material and rotate. The wavelength conversion material is disposed on the wavelength conversion area. The wavelength conversion element 120 is used to switch the wavelength conversion area and the non-wavelength conversion area into the transmission path of the laser beam L1 by rotating at different timings. The wavelength conversion material is, for example, a phosphor material of a yellow color and/or a green color, used to convert the laser beam L1 of the blue color into the converted light beam L2 of the yellow color and/or the green color. The converted light beam L2 may include a green light beam and a red light beam as a source of a red light part and a green light part of the illumination light beam LB. In this embodiment, the wavelength conversion element 120 includes, for example, a light-transmitting element. The light-transmitting element is, for example, glass. For example, in a first timing interval, the non-wavelength conversion area is located on the transmission path of the laser beam L1. After the laser beam L1 passes through the wavelength conversion element 120, the laser beam L1 is transmitted to the light splitting element 140. In a second timing interval, the wavelength conversion area is located on the transmission path of the laser beam L1. After the laser beam L1 is converted into the converted light beam L2 by the wavelength conversion element 120, the converted light beam L2 is transmitted to the light splitting element 140.

The first supplementary light source 130 is used to provide a first supplementary light beam L3. A wavelength of the first supplementary light beam L3 is within a second wavelength range. For example, the first supplementary light source 130 is at least one red laser diode, at least one red light emitting diode, a red laser diode array, or a red light emitting diode array. The first supplementary light source 130 is used to provide the first supplementary light beam L3 of the red color. The second wavelength range falls between 600 nm and 670 nm, or between 620 nm and 660 nm. In another embodiment, the first supplementary light source 130 is, for example, at least one green laser diode, at least one green light emitting diode, a green laser diode array, or a green light emitting diode array. The first supplementary light source 130 is used to provide the first supplementary light beam L3 of the green color. The second wavelength range falls between 500 nm and 560 nm, or between 515 nm and 535 nm. A polarization state of the first supplementary light beam L3 includes a first polarization state and a second polarization state. In this embodiment, the polarization state is a linear polarization state. The first polarization state and the second polarization state are, for example, a P linear polarization state and an S linear polarization state respectively. In this embodiment, a ratio of energy of the first supplementary light beam L3 having the first polarization state and energy of the first supplementary light beam L3 having the second polarization state provided by the first supplementary light source 130 is greater than 2 to 1. In an embodiment, the first supplementary beam L3 has the characteristics of a single polarization (single polarity). Most of the first supplementary light beam L3 is the first supplementary light beam L3 with the P linear polarization state. For example, the ratio of the energy of the first supplementary beam L3 having the P linear polarization state to the energy of the first supplementary beam L3 having the S linear polarization state is 97 to 3.

In this embodiment, the illumination system 100 may further include a light homogenizing element 150 configured on the transmission path of the illumination light beam LB to adjust the shape of a light spot formed by the illumination light beam LB on the light valve 60 so that the shape of the light spot may match the shape of a working area of the light valve 60 (for example, rectangular). The light spot has a consistent or close light intensity at various places, so as to uniform the light intensity of the illumination light beam LB. The illumination light beam LB includes at least one of the laser beam L1, the converted light beam L2, and the first supplementary light beam L3. In this embodiment, the light homogenizing element 150 is, for example, an integrating rod, a lens array (a fly eye lens array), or other appropriate types of optical elements. In this embodiment, the transmission path of the first supplementary light beam L3 from the first supplementary light source 130 to the light splitting element 140 includes neither a molded light-transmitting element nor a reinforced light-transmitting element. The molded light-transmitting element and the reinforced light-transmitting element may destroy the polarization state of the light beam. The molded light-transmitting element is, for example, molded glass. The reinforced light-transmitting element is, for example, tempered glass. In this way, the polarization state of the first supplementary light beam L3 transmitted to the light splitting element 140 may be maintained.

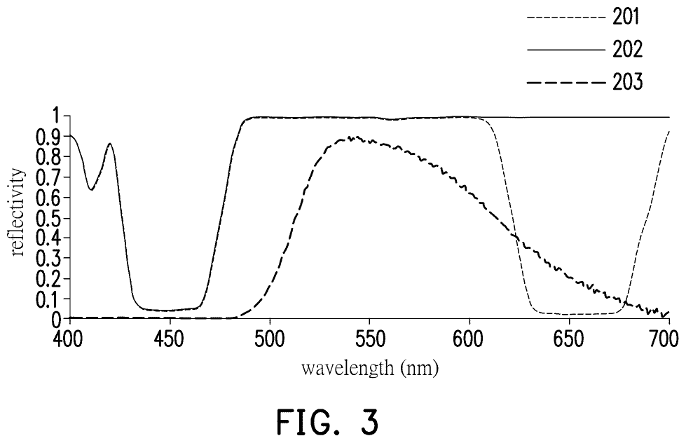

FIG. 3 is a reflectivity curve in different wavelength bands of the light splitting element of the illumination system of FIG. 2. Referring to both FIG. 2 and FIG. 3, a reflectivity of 1 in FIG. 3 means 100% reflectivity, a reflectivity of 0 means 0% reflectivity, and so on. The light splitting element 140 is configured on the transmission path of a laser beam L1, the first supplementary beam L3, and the converted light beam L2. The light splitting element 140 is, for example, a beam splitter with a coating on the light-transmitting element, and is used to allow a specific wavelength beam of a specific polarization state to pass through or reflect. In this embodiment, the light splitting element 140 is used to allow the laser beam L1 with a wavelength within the first wavelength range to pass through, allow the first supplementary beam L3 with a wavelength within the second wavelength range and having the first polarization state to pass through, and reflect the converted light beam L2 with a wavelength within the second wavelength range and having the second polarization state. The polarization state of the converted light beam L2 includes the first polarization state and the second polarization state. The ratio of the energy of the converted light beam L2 with the first polarization state to the energy of the converted light beam L2 with the second polarization state is approximately 1 to 1. A transmittance of the first supplementary light beam L3 with the wavelength within the second wavelength range and having the first polarization state at the light splitting element 140 is greater than or equal to 70% or greater than or equal to 90%. In this embodiment, the light splitting element 140 is also used to reflect the converted light beam L2 with a wavelength that is not within the first wavelength range and the second wavelength range. For example, the first supplementary light source 130 provides the first supplementary beam L3 of the red color, and the second wavelength range falls between 600 nm and 670 nm. In this embodiment, the light splitting element 140 is used to allow the laser beam L1 of the blue color with a wavelength between 380 nm and 495 nm to pass through. The light splitting element 140 is used to allow the first supplementary beam L3 of the red color with a wavelength falling between 600 nm and 670 nm and having the P linear polarization state to pass through, and reflect the converted light beam L2 of the red color (a red light beam) with a wavelength falling between 600 nm and 670 nm and having the S linear polarization state. The light splitting element 140 is used to reflect the converted light beam L2 of the green color (a green light beam) with a wavelength between 495 nm and 600 nm. The first supplementary beam L3 (the red light beam) having the P linear polarization state from the light splitting element 140, the laser beam L1 (a blue light beam), the converted light beam L2 (the red light beam) with the wavelength falling between 600 nm and 670 nm and having the S linear polarization state, and the converted light beam L2 (for example, the green light beam) of other wavelength bands are transmitted to the light homogenizing element 150.

In this embodiment, the reflectivity of the light splitting element 140 for a first polarized beam falling in different wavelength intervals is different from the reflectivity for a second polarized beam falling in different wavelength intervals. The reflectivity of a first polarized beam falling in different wavelength intervals is shown in a curve 201 of FIG. 3. The reflectivity of the second polarized beam falling in different wavelength intervals is shown in a curve 202 of FIG. 3. The light intensity of the converted light beam L2 at different wavelengths is shown in a curve 203 of FIG. 3. The curve 201 and the curve 202 overlaps in the portion outside the second wavelength range (falling between 600 nm and 670 nm). Under the architecture of the illumination system 100 with the first supplementary light source 130, the light splitting element 140 of this embodiment may reflect the converted light beam L2 (the red light beam) with the wavelength between 600 nm and 670 nm and having the S linear polarization state to the light homogenizing element 150. Compared with the conventional light splitting element, which allows the light beams of all polarization states with wavelengths between 600 nm and 670 nm to pass through, thereby causing all light losses in the wavelength band, the light splitting element 140 of this embodiment has proper light collection efficiency. Since the light splitting element 140 of this embodiment only considers the polarization state of the light beam with the wavelength within the second wavelength range, the coating process is relatively simple, and a slope of the curve 201 in the second wavelength range is relatively high. The light collection efficiency of the converted light beam L2 is relatively high, which may avoid the energy loss of part of the converted beam L2 caused by the multiple coating processes of the light splitting elements, thereby improving the usage efficiency of light to achieve proper optical effects.

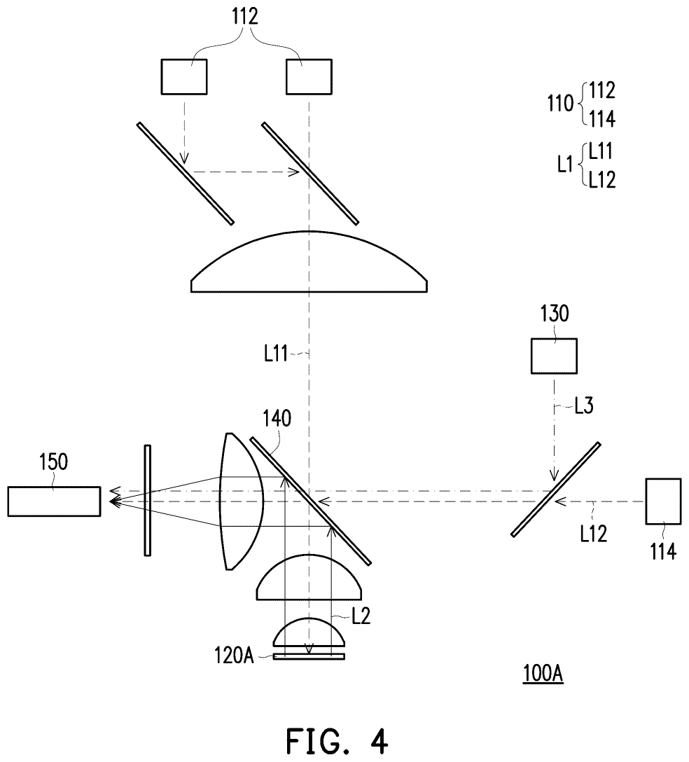

FIG. 4 is a schematic diagram of an illumination system according to another embodiment of the disclosure. Referring to FIG. 4, the architecture and advantages of an illumination system 100A of FIG. 4 are similar to the illumination system 100 of FIG. 2. The difference between the two is that in this embodiment, the wavelength conversion element 120A is a reflective optical component with the wavelength conversion area and without a transparent area. The laser light source 110 includes a first laser light source 112 and a second laser light source 114. The first laser light source 112 is used to provide a first laser beam L11. The wavelength conversion element 120A is configured on the transmission path of the first laser beam L11. The second laser light source 114 is used to provide a second laser beam L12. The second laser beam L12 enters the light homogenizing element 150 by the guiding of the light splitting element 140. The laser beam L1 includes the first laser beam L11 and the second laser beam L12. For example, the first laser light source 112 and the second laser light source 114 are at least one blue laser diode or blue laser diode array, used to provide the first laser beam L11 and the second laser beam L12 of the blue color. The main wavelength of the first laser beam L11 is, for example, 455 nm. The main wavelength of the second laser beam L12 is, for example, 465 nm. The second laser beam L12 is transmitted from the second laser light source 114 to the light homogenizing element 150 by the guiding of the light splitting element 140 to be used as a blue light portion of the illumination light beam LB.

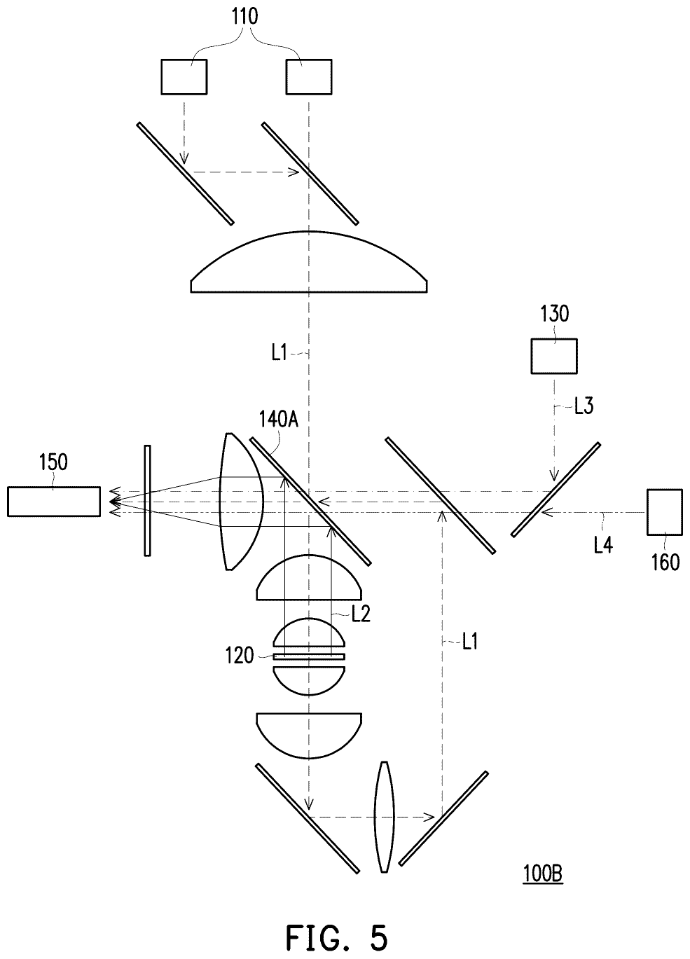

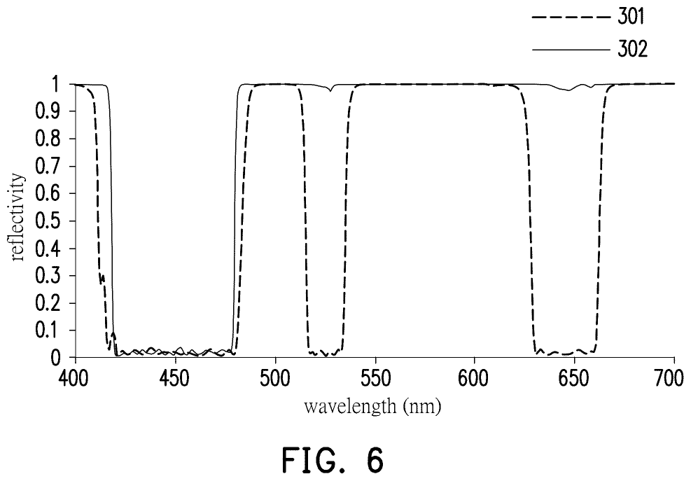

FIG. 5 is a schematic diagram of an illumination system according to another embodiment of the disclosure. FIG. 6 is a reflectivity curve in different wavelength bands of the light splitting element of the illumination system of FIG. 5. Referring to FIG. 5 and FIG. 6, an illumination system 100B of FIG. 5 is similar to the illumination system 100 of FIG. 2. The difference between the two is that in this embodiment, the illumination system 100B further includes a second supplementary light source 160 to provide a second supplementary light beam L4. A wavelength of the second supplementary light beam LA is within a third wavelength range. The second supplementary light source 160 may be configured on a side of a light splitting element 140A facing the first supplementary light source 130. The light splitting element 140A is located between the light homogenizing element 150 and the second supplementary light source 160. For example, the first supplementary light source 130 is used to provide the first supplementary light beam L3 of the red color. The second supplementary light source 160 is, for example, the at least one green laser diode, the at least one green light emitting diode, the green laser diode array, or the green light emitting diode array, for providing the second supplementary light beam L4 of the green color. The third wavelength range falls between 500 nm and 560 nm, or alternatively, between 515 nm and 535 nm. The second supplementary light beam L4 is transmitted from the second supplementary light source 160 to the light homogenizing element 150 by the guiding of the light splitting element 140A to supplement a green light portion of the illumination light beam LB. The polarization state of the second supplementary light beam L4 includes the first polarization state and the second polarization state. In this embodiment, the transmission path of the second supplementary light beam L4 from the second supplementary light source 160 to the light splitting element 140A includes neither the molded light-transmitting element nor the reinforced light-transmitting element. In this way, the polarization state of the second supplementary light beam L4 transmitted to the light splitting element 140A may be maintained. In this embodiment, the ratio of the energy of the second supplementary light beam L4 with the first polarization state (the P linear polarization state) provided by the second supplementary light source 160 to the energy of the second supplementary beam light L4 with the second polarization state (the S linear polarization state) is greater than 2 to 1. In an embodiment, the second supplementary light beam L4 has the characteristics of the single polarization. Most of the second supplementary light beam LA is the second supplementary light beam L4 with the P linear polarization state. For example, the ratio of the energy of the second supplementary light beam L4 with the P linear polarization state to the energy of the second supplementary light beam L4 with the S linear polarization state is 97 to 3.

In this embodiment, the light splitting element 140A is configured on the transmission path of the laser beam L1, the converted light beam L2, the first supplementary light beam L3, and the second supplementary light beam L4 to respectively allow light beams with specific wavelengths of different polarization states to pass through or to reflect. The illumination light beam LB includes at least one of the laser beam L1, the converted light beam L2, the first supplementary light beam L3, and the second supplementary light beam L4. In this embodiment, the light splitting element 140A is used to allow the laser beam L1 (the blue light beam) with the wavelength within the first wavelength range to pass through, allow the first supplementary light beam L3 (the red light beam) with the wavelength within the second wavelength range and having the first polarization state to pass through, and reflect the converted light beam L2 (the red light beam) with the wavelength within the second wavelength range and having the second polarization state. The light splitting element 140A is used to allow the second supplementary light beam L4 (the green light beam) with the wavelength within the third wavelength range and having the first polarization state to pass through, and reflect the converted light beam L2 (the green light beam) with the wavelength within the third wavelength range and having the second polarization state. The light splitting element 140A is further used to reflect the converted light beam L2 with the wavelength that is not within the first wavelength range, the second wavelength range, and the third wavelength range. For example, in this embodiment, the light splitting element 140A is used to allow the laser beam L1 (the blue light beam) with the wavelength between 380 nm and 495 nm to pass through. The light splitting element 140A is used to allow the first supplementary light beam L3 (the red light beam) with the wavelength between 600 nm and 670 nm and having the P linear polarization state to pass through, and reflect the converted light beam L2 (the red light beam) with the wavelength between 600 nm and 670 nm and having the S linear polarization state. The light splitting element 140A is used to allow the second supplementary light beam L4 (the green light beam) with the wavelength between 500 nm and 560 nm and having the P linear polarization state to pass through, reflect the converted light beam L2 (the green light beam) with the wavelength between 500 nm and 560 nm and having the S linear polarization state, and reflect the converted light beam L2 with the wavelength between 560 nm and 600 nm.

In this embodiment, the reflectivity of the light splitting element 140A for the first polarized light beam falling in different wavelength intervals is different from the reflectivity for the second polarized light beam falling in different wavelength intervals. The reflectivity of the first polarized light beam falling in different wavelength intervals is shown in a curve 301 of FIG. 6. The reflectivity of the second polarized light beam falling in different wavelength intervals is shown in a curve 302 of FIG. 6. The curve 301 and the curve 302 overlap in the portion outside the first wavelength range (falling between 380 nm and 495 nm), the second wavelength range (falling between 600 nm and 670 nm), and the third wavelength range (falling between 500 nm and 560 nm). Under the architecture of the illumination system 100B with the first supplementary light source 130 and the second supplementary light source 160, the light splitting element 140A of this embodiment may reflect the converted light beam L2 (the red light beam) with the wavelength between 600 nm and 670 nm and having the S linear polarization state to the light homogenizing element 150, and reflect the converted light beam L2 (the green light beam) with the wavelength between 500 nm and 560 nm and having the S linear polarization state to the light homogenizing element 150. Compared with the conventional light splitting element that allows all polarized light beams with wavelengths between 500 nm to 560 nm and 600 nm to 670 nm to pass through, causing all light losses in the wavelength bands, the light splitting element 140A of this embodiment has proper light collection efficiency. Since the light splitting element 140A of this embodiment only considers the polarization state of the light beam with the wavelength falling within the second wavelength range and the third wavelength range, the coating process is relatively simple, and a slope of the curve 301 in the second wavelength range and the third wavelength range is relatively high. The light collection efficiency of the converted light beam L2 is relatively high, which may avoid the energy loss of part of the converted light beam L2 caused by the multiple coating processes of the light splitting elements under the architecture of the illumination system 100B having supplementary light sources, thereby improving the usage efficiency of light to achieve proper optical effects.

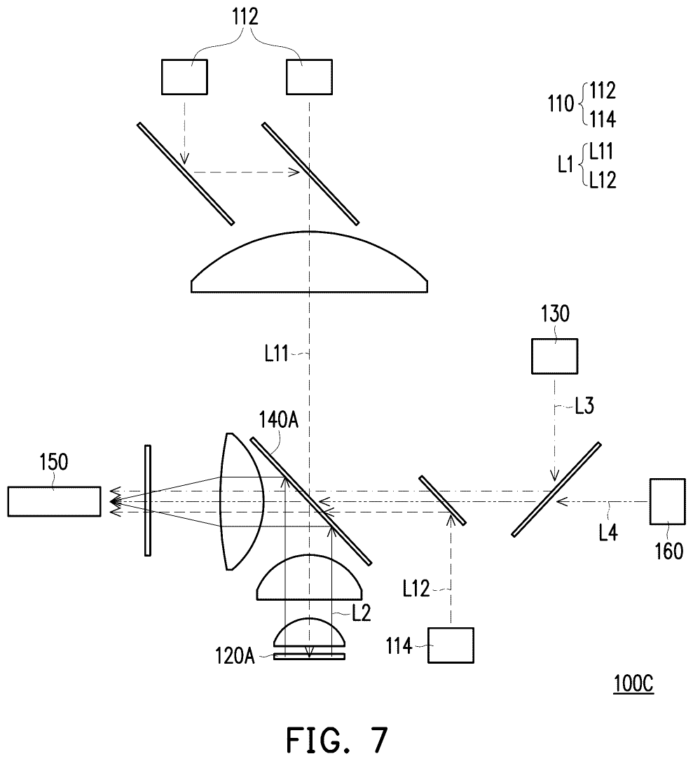

FIG. 7 is a schematic diagram of an illumination system according to another embodiment of the disclosure. Referring to FIG. 7, the architecture and advantages of an illumination system 100C of FIG. 7 are similar to the illumination system 100B of FIG. 5. The difference between the two is that in this embodiment, the wavelength conversion element 120A is the reflective optical component with the wavelength conversion area and without the transparent area. The laser light source 110 includes the first laser light source 112 and the second laser light source 114. The first laser light source 112 is used to provide the first laser beam L11. The wavelength conversion element 120A is configured on the transmission path of the first laser beam L11. The second laser light source 114 is used to provide the second laser beam L12. The second laser beam L12 enters the light homogenizing element 150 by the guiding of the light splitting element 140. The laser beam L1 includes the first laser beam L11 and the second laser beam L12. For example, the first laser light source 112 and the second laser light source 114 are the at least one blue laser diode or the blue laser diode array, used to provide the first laser beam L11 and the second laser beam L12 of the blue color. The main wavelength of the first laser beam L11 is, for example, 455 nm. The main wavelength of the second laser beam L12 is, for example, 465 nm. The second laser beam L12 is transmitted from the second laser light source 114 to the light homogenizing element 150 by the guiding of the light splitting element 140 to be used as the blue light portion of the illumination light beam LB.

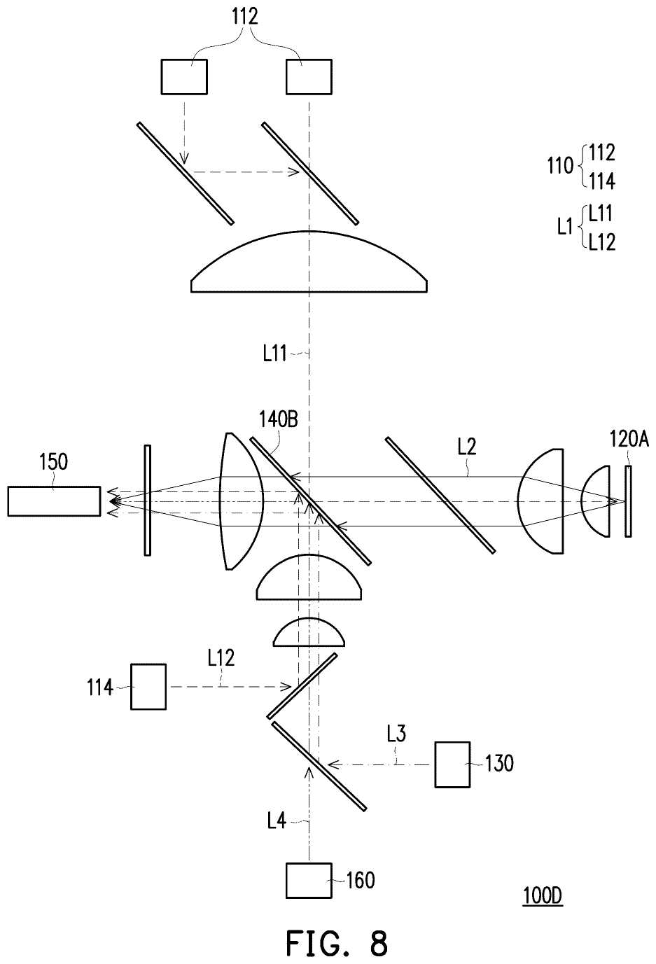

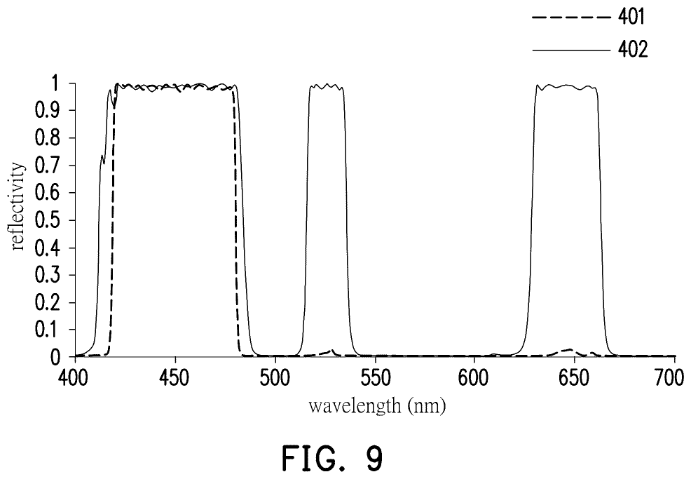

FIG. 8 is a schematic diagram of an illumination system according to another embodiment of the disclosure. FIG. 9 is a reflectivity curve in different wavelength bands of the light splitting element of the illumination system of FIG. 8. Referring to FIG. 8 and FIG. 9, an illumination system 100D of FIG. 8 is similar to the illumination system 100C of FIG. 7. The difference between the two is that in this embodiment, the combination of the first supplementary light source 130, the second supplementary light source 160, and the second laser light source 114 is configured in exchange with the wavelength conversion element 120A. A light splitting element 140B is located between the wavelength conversion element 120A and the light homogenizing element 150, and also between the first laser light source 112 and the second supplementary light source 160. In this embodiment, the light splitting element 140B is used to reflect the laser beam L1 (the blue light beam) with the wavelength within the first wavelength range, reflect the first supplementary beam L1 (the red light beam) with the wavelength within the second wavelength range and having the second polarization state, and allow the converted light beam L2 (the red light beam) with the wavelength within the second wavelength range and having the first polarization state to pass through. The light splitting element 140B is further used to reflect the second supplementary light beam L4 (the green light beam) with the wavelength within the third wavelength range and having the second polarization state, and allow the converted light beam L2 (the green light beam) with the wavelength within the third wavelength range and having the first polarization state to pass through. In this embodiment, the ratio of the energy of the first supplementary light beam L3 with the first polarization state (the P linear polarization state) provided by the first supplementary light source 130 to the energy of the first supplementary light beam L1 with the second polarization state (the S linear polarization state) is less than 1 to 2. The ratio of the energy of the second supplementary light beam L4 with the first polarization state (the P linear polarization state) provided by the second supplementary light source 160 to the energy of the first supplementary light beam L1 with the second polarization state (the S linear polarization state) is less than 1 to 2. In an embodiment, the first supplementary light beam L1 and the second supplementary light beam L4 have the characteristic of the single polarization, and most of the first supplementary light beam L1 and the second supplementary light beam L4 are light beams with the S linear polarization state. For example, the ratio of the energy of the first supplementary beam L1 with the S linear polarization state to the energy of the first supplementary beam L1 with the P linear polarization state is 97 to 3. The ratio of the energy of the second supplementary light beam L4 with the S linear polarization state to the energy of the second supplementary light beam L4 with the P linear polarization state is 97 to 3.

For example, in this embodiment, the light splitting element 140B is used to reflect the laser beam L1 of the blue color (the blue light beam) with the wavelength between 380 nm and 495 nm. The light splitting element 140B is used to reflect the first supplementary light beam L3 of the red color (the red light beam) with the wavelength between 600 nm and 670 nm and having the S linear polarization state, and to reflect the second supplementary light beam LA of the green color (the green light beam) with the wavelength between 500 nm and 560 nm and having the S linear polarization state. The light splitting element 140B is used to allow the converted light beam L2 (the green light beam and the red light beam) with the wavelength outside 380 nm to 495 nm and having the P linear polarization state to pass through. In other words, in this embodiment, the reflectivity of the light splitting element 140B for the first polarized light beam falling in different wavelength intervals is different from the reflectivity of the second polarized light beam falling in different wavelength intervals. The reflectivity of the first polarized light beam falling in different wavelength intervals is shown in a curve 401 of FIG. 9. The reflectivity of the second polarized light beam falling in different wavelength intervals is shown in a curve 402 of FIG. 9. The curves 401 and 402 overlap in the portion outside the second wavelength range (falling between 600 nm and 670 nm) and the third wavelength range (falling between 500 nm and 560 nm).

Under the architecture of the illumination system 100D with the first supplementary light source 130 and the second supplementary light source 160, the light splitting element 140B of this embodiment may allow the converted light beam L2 (the green light beam) with the wavelength between 500 nm and 560 nm and having the P linear polarization state and the converted light beam L2 (the red light beam) with the wavelength between 600 nm and 670 nm and having the P linear polarization state to pass to the light homogenizing element 150. The light splitting element 140B is further used to allow the converted light beam L2 with the wavelength that is not located at the first wavelength range, the second wavelength range, and the third wavelength range to pass through. For example, the light splitting element 140B is used to allow the converted light beam L2 with the wavelength falling between 540 nm and 630 nm to pass through. Compared with the conventional light splitting element that reflects all polarized light beams with wavelengths between 500 nm and 670 nm, causing all light losses in the wavelength band, the light splitting element 140B of this embodiment has a relatively proper light collection efficiency. Since the light splitting element 140B of this embodiment only considers the polarization state of the light beam with wavelength falling within the second wavelength range and the third wavelength range, the coating process is relatively simple, and a slope of the curve 402 within the second wavelength range and the third wavelength range is relatively high. The light collection efficiency of the converted light beam L2 is relatively high, which may avoid the energy loss of part of the converted light beam L2 caused by the multiple coating processes of the light splitting elements under the architecture of the illumination system 100D having supplementary light sources, thereby improving the usage efficiency of light to achieve proper optical effects.

To sum up, under the architecture of the illumination system and the projection device with the supplementary light source of the disclosure, through the design of the light splitting element, the light beam in the wavelength band corresponding to the supplementary light source may penetrate the light splitting element at the first polarization state and be reflected by the light splitting element at the second polarization state. In this way, the usage efficiency of light can be improved to achieve proper optical effects.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An illumination system, comprising a laser light source, a wavelength conversion element, a first supplementary light source, and a light splitting element, wherein:
the laser light source is used to provide a laser beam, a wavelength of the laser beam is within a first wavelength range;
the wavelength conversion element is configured on a transmission path of the laser beam, and the wavelength conversion element is configured to convert the laser beam into a converted light beam;
the first supplementary light source is configured to provide a first supplementary light beam, a wavelength of the first supplementary light beam is within a second wavelength range, and a polarization state of the first supplementary light beam comprises a first polarization state and a second polarization state; and
the light splitting element is configured on a transmission path of the laser beam, the first supplementary beam, and the converted light beam, and the light splitting element meets one of the following conditions:
(1) allowing the laser beam with a wavelength within the first wavelength range to pass through, allowing the first supplementary beam with a wavelength within the second wavelength range and having the first polarization state to pass through, and reflecting the converted light beam with a wavelength within the second wavelength range and having the second polarization state; or
(2) reflecting the laser beam with a wavelength within the first wavelength range, reflecting the first supplementary beam with a wavelength within the second wavelength range and having the second polarization state, and allowing the converted light beam with a wavelength within the second wavelength range and having the first polarization state to pass through.

2. The illumination system according to claim 1, wherein the first wavelength range falls between 380 nm and 495 nm, and the second wavelength range falls between 500 nm and 560 nm or falls between 600 nm and 670 nm.

3. The illumination system according to claim 1, wherein in response to the light splitting element meeting the condition (1), the light splitting element is further configured to reflect the converted light beam with a wavelength being not within the first wavelength range and the second wavelength range, and in response to the light splitting element meeting the condition (2), the light splitting element is further configured to allow the converted light beam with a wavelength being not within the first wavelength range and the second wavelength range to pass through.

4. The illumination system according to claim 1, wherein in response to the light splitting element meeting the condition (1), a ratio of energy of the first supplementary light beam with the first polarization state provided by the first supplementary light source to energy of the first supplementary light beam with the second polarization state is greater than 2 to 1, and in response to the light splitting element meeting the condition (2), a ratio of energy of the first supplementary light beam with the first polarization state provided by the first supplementary light source to energy of the first supplementary light beam with the first polarization state is less than 1 to 2.

5. The illumination system according to claim 1, wherein the transmission path of the first supplementary light beam from the first supplementary light source to the light splitting element comprises neither a molded light-transmitting element nor a reinforced light-transmitting element.

6. The illumination system according to claim 1, wherein a transmittance of the light splitting element to a light beam with a wavelength within the second wavelength range and having the first polarization state is greater than or equal to 70%.

7. The illumination system according to claim 1, further comprising a second supplementary light source configured to provide a second supplementary light beam, wherein a wavelength of the second supplementary light beam is within a third wavelength range, and the polarization state of the second supplementary light beam comprises the first polarization state and the second polarization state, wherein the light splitting element is further configured to allow a light beam with a wavelength within the third wavelength range and having the first polarization state to pass through, and reflect the light beam with the wavelength within the third wavelength range and having the second polarization state.

8. The illumination system according to claim 7, wherein the first wavelength range falls between 380 nm and 495 nm, the second wavelength range falls between 600 nm and 670 nm, and the third wavelength range falls between 500 nm and 560 nm.

9. The illumination system according to claim 7, wherein a transmission path of the second supplementary light beam from the second supplementary light source to the light splitting element comprises neither a molded light-transmitting element nor a reinforced light-transmitting element.

10. The illumination system according to claim 1, wherein the laser light source comprises a first laser light source and a second laser light source, the first laser light source is configured to provide a first laser beam, the wavelength conversion element is configured on a transmission path of the first laser beam, the second laser light source is configured to provide a second laser beam, and the second laser beam enters a light homogenizing element by guiding of the light splitting element.

11. The illumination system according to claim 1, further comprising a second supplementary light source configured to provide a second supplementary light beam, wherein the light splitting element is further configured to allow a part of the second supplementary light beam to pass through, and reflect another part the second supplementary light beam; wherein the laser light source comprises a first laser light source and a second laser light source, the first laser light source is configured to provide a first laser beam, the wavelength conversion element is configured to be located on a transmission path of the first laser beam, the second laser light source is configured to provide a second laser beam, and the second laser beam enters a light homogenizing element by guiding of the light splitting element.

12. A projection device, comprising an illumination system, at least one light valve, and a projection lens, wherein:
the illumination system is configured to provide an illumination light beam, the illumination system comprises a laser light source, a wavelength conversion element, a first supplementary light source, and a light splitting element, wherein:
the laser light source is configured to provide a laser beam, a wavelength of the laser beam is within the first wavelength range;
the wavelength conversion element is configured on a transmission path of the laser beam, and the wavelength conversion element is configured to convert the laser beam into a converted light beam;
the first supplementary light source is configured to provide a first supplementary light beam, a wavelength of the first supplementary light beam is within a second wavelength range, and a polarization state of the first supplementary light beam comprises a first polarization state and a second polarization state; and
the light splitting element is configured on a transmission path of the laser beam, the first supplementary beam, and the converted light beam, the illumination beam comprises at least one of the laser beam, the first supplementary beam, and the converted light beam, and the light splitting element meets one of the following conditions:
(1) allowing the laser beam with a wavelength within the first wavelength range to pass through, allowing a beam with a wavelength within the second wavelength range and having the first polarization state to pass through, and reflecting the converted light beam with a wavelength within the second wavelength range and having the second polarization state; or
(2) reflecting the laser beam with a wavelength within the first wavelength range, reflecting the first supplementary beam with a wavelength within the second wavelength range and having the second polarization state, and allowing the converted light beam with a wavelength within the second wavelength range and having the first polarization state to pass through;
the at least one light valve is configured on a transmission path of the illumination light beam to convert the illumination light beam into an image beam; and
the projection lens is configured on a transmission path of the image beam and is configured to project the image beam out of the projection device.

13. The projection device according to claim 12, wherein the first wavelength range falls between 380 nm and 495 nm, and the second wavelength range falls between 500 nm and 560 nm or between 600 nm and 670 nm.

14. The projection device according to claim 12, wherein in response to the light splitting element meeting the condition (1), the light splitting element is further configured to reflect the converted light beam with a wavelength being not within the first wavelength range and the second wavelength range, and in response to the light splitting element meeting the condition (2), the light splitting element is further configured to allow the converted light beam with a wavelength being not within the first wavelength range and the second wavelength range to pass through.

15. The projection device according to claim 12, wherein in response to the light splitting element meeting the condition (1), a ratio of energy of the first supplementary light beam with the first polarization state provided by the first supplementary light source to energy of the first supplementary light beam with the second polarization state is greater than 2 to 1, and in response to the light splitting element meeting the condition (2), a ratio of energy of the first supplementary light beam with the first polarization state provided by the first supplementary light source to energy of the first supplementary light beam with the first polarization state is less than 1 to 2.

16. The projection device according to claim 12, wherein the transmission path of the first supplementary light beam from the first supplementary light source to the light splitting element comprises neither a molded light-transmitting element nor a reinforced light-transmitting element.

17. The projection device according to claim 12, wherein a transmittance of the light splitting element to a light beam with a wavelength in the second wavelength range and having the first polarization state is greater than or equal to 70%.

18. The projection device according to claim 12, wherein the illumination system further comprises a second supplementary light source to provide a second supplementary light beam, a wavelength of the second supplementary light beam is within a third wavelength range, and a polarization state of the second supplementary light beam comprises a first polarization state and a second polarization state, wherein the light splitting element is further configured to allow the light beam with the wavelength within the third wavelength range and having the first polarization state to pass through, and reflect a light beam with a wavelength in the third wavelength range and having the second polarization state.

19. The projection device according to claim 18, wherein the first wavelength range falls between 380 nm and 495 nm, the second wavelength range falls between 600 nm and 670 nm, and the third wavelength range falls between 500 nm and 560 nm.

20. The projection device according to claim 18, wherein a transmission path of the second supplementary light beam from the second supplementary light source to the light splitting element comprises neither a molded light-transmitting element nor a reinforced light-transmitting element.

21. The projection device according to claim 12, wherein the laser light source comprises a first laser light source and a second laser light source, the first laser light source is configured to provide a first laser beam, the wavelength conversion element is configured on a transmission path of the first laser beam, the second laser light source is configured to provide a second laser beam, and the second laser beam enters a light homogenizing element by guiding of the light splitting element.

22. The projection device according to claim 12, wherein the illumination system further comprises a second supplementary light source configured to provide a second supplementary light beam, wherein the light splitting element is further configured to allow a part of the second supplementary light beam to pass through, and reflect another part the second supplementary light beam; wherein the laser light source comprises a first laser light source and a second laser light source, the first laser light source is configured to provide a first laser beam, the wavelength conversion element is configured to be located on a transmission path of the first laser beam, the second laser light source is configured to provide a second laser beam, and the second laser beam enters a light homogenizing element by guiding of the light splitting element.
